(19) United States
(12) Patent Application Publication
(10) Pub. No.: US 2013/0324035 A1
(43) Pub. Date: Dec. 5, 2013

(54) METHODOLOGY FOR USING SMARTPHONE IN DESKTOP OR MOBILE COMPUTE ENVIRONMENT

(71) Applicant: Timothy K. Strommen, Fremont, CA (US)

(72) Inventor: Timothy K. Strommen, Fremont, CA (US)

(73) Assignee: NVIDIA CORPORATION, Santa Clara, CA (US)

(21) Appl. No.: 13/487,021

(22) Filed: Jun. 1, 2012

(51) Int. Cl. G06F 3/01; H04B 5/00

(52) U.S. Cl. CPC G06F 3/01; H04B 5/0025
USPC 455/41.1

(57) ABSTRACT

Embodiments of the present invention may be directed to an apparatus comprising a user interface device. The user interface device may include one or more peripheral units and a first circuit operable to create a pairing between the user interface device and a wireless computing device via a near-field wireless connection. The peripheral units may include a second circuit operable to create a wireless communication channel between the one or more peripheral units and the wireless computing device via a wireless communication protocol. The apparatus may also include an inductive charging pad operable for charging the wireless computing device. The inductive charging pad may generate a configuration eligibility signal indicating eligibility of the wireless computing device to connect to the one or more peripheral units upon the wireless computing device placed in proximity to the inductive charging pad.

### CROSS-REFERENCE TO RELATED APPLICATION

This application is related to patent application, “METHODOLOGY FOR USING SMARTPHONE AND MOBILE COMPUTER IN A MOBILE COMPUTE ENVIRONMENT,” concurrently filed with this application, with attorney docket number NVID-P-SC-11-0266-US2, which is herein incorporated by reference in its entirety.

### BACKGROUND OF THE INVENTION

Historical designs of desktop personal computers include a box or chassis containing the main computer components such as a power supply, central processing unit, memory, and data storage. Typically, attached to the box or chassis is a display device and one or more user interface devices for a user to interact with the personal computer.

With the advent of more powerful mobile central processing units, consumers now have mobile computing devices that include the major components of a traditional personal computer. However, the mobile form factor has some drawbacks such as limited screen-size, limited user interface area, and limited battery life preventing long-running applications typically used in a business environment from running.

Some specifications have attempted to address the limitations of mobile computing devices by mirroring the smaller mobile display to a larger external display. This type of mirroring currently requires a physical display connection, e.g. HDMI cable, to be connected from the mobile computing device to the larger external display. Some specifications have attempted to address the user interface limitation issue by using industry standard wired or wireless keyboards and mice to pair with the mobile computing device. However, these solutions require the user to manually set up the pairing with continued repeated effort for each device. Some specifications have attempted to address the limited battery life issue by requiring the user to plug in the mobile computing device to a physical power source. However, this solution also requires effort on the part of the user each time the user wishes use the mobile computing device in a mobile desktop environment.

These solutions have partly addressed the separate issues presented by a mobile computing environment ecosystem, however there is no integrated solution available allowing for a user to sit down with a mobile computing device and begin their workflow in a mobile computing environment with minimal user initial setup and effort.

### BRIEF SUMMARY OF THE INVENTION

Accordingly, a need exists for a methodology to integrate a mobile computing device into a desktop or mobile compute environment by combining multiple technologies into one harmonious solution.

Embodiments of the present invention are directed to an apparatus for a mobile compute environment. More specifically, the apparatus may include a user interface device having one or more peripheral units and a first circuit. The first circuit is operable to create a pairing between the user interface device and a wireless computing device via a near-field wireless connection. The one or more peripheral units may include a second circuit operable to create a wireless communication channel between the one or more peripheral units and the wireless computing device via a wireless communication protocol. The apparatus may also include an inductive charging pad operable for charging the wireless computing device when the wireless computing device is placed in proximity to the inductive charging pad. The inductive charging pad may also generate a configuration eligibility signal when the wireless computing device is placed in proximity to the inductive charging pad.

Another embodiment of the present invention may be directed to an apparatus for a mobile compute environment where a wireless computer may be used as a user input device. More specifically, the wireless computer may automatically implement user input device functionality e.g., a cursor-directing device, upon placing the wireless computer in proximity to an inductive charging pad. The wireless computer may act as a cursor-directing device having a high-resolution camera operable to be used as an optical mouse sensor. The wireless computer may also act as a cursor-directing device having a multi-touch display operable to recognize navigation gestures by a user.

Other embodiments of the present invention may be directed to a method of pairing a wireless computing device with a user interface device. More specifically, the method may include detecting whether the wireless computing device is within proximity to the user input device. Upon detecting whether the wireless computing device is within proximity to the user input device, the method may also include creating a near-field wireless connection between the wireless computing device and the user interface device. A configuration eligibility signal may be generated indicating eligibility of the wireless computing device to connect to one or more peripheral units of the user interface device. The method may also include connecting the wireless computing device to the one or more peripheral units by creating a secure wireless session between the wireless computing device and the one or more peripheral units according to a wireless communication protocol.

### BRIEF DESCRIPTION OF THE DRAWINGS

The present invention is illustrated by way of example, and not by way of limitation, in the figures of the accompanying drawings and in which like reference numerals refer to similar elements.

FIG. 1 depicts a prior art personal computer system.

FIG. 2 depicts a prior art wireless computing device.

FIG. 3 depicts an exemplary user interface device along with an inductive charging pad in accordance with one embodiment of the present invention.

FIG. 4 depicts an exemplary user interface device along with a wireless computing device in proximity to an inductive charging pad in accordance with one embodiment of the present invention.

FIG. 5 depicts a block diagram of a mobile compute environment in accordance with one embodiment of the present invention.

FIG. 6A depicts a wireless computing device operable as a user input device in accordance with one embodiment of the present invention.

FIG. 6B depicts a wireless computing device operable as a cursor-directing device in accordance with one embodiment of the present invention.

FIG. 7 depicts a wireless computing device having a built in camera operable as a tracking sensor for a user input device in accordance with one embodiment of the present invention.

FIG. 8 depicts a user interface device having a slot operable to house a wireless computing device in accordance with one embodiment of the present invention.

FIG. 9 depicts a flowchart of an exemplary process of pairing a wireless computing device with a user interface device, according to some embodiments of the present invention.

### DETAILED DESCRIPTION OF THE INVENTION

Reference will now be made in detail to embodiments of the present invention, examples of which are illustrated in the accompanying drawings. While the present invention will be discussed in conjunction with the following embodiments, it will be understood that they are not intended to limit the present invention to these embodiments alone. On the contrary, the present invention is intended to cover alternatives, modifications, and equivalents which may be included with the spirit and scope of the present invention as defined by the appended claims. Furthermore, in the following detailed description of the present invention, numerous specific details are set forth in order to provide a thorough understanding of the present invention. However, embodiments of the present invention may be practiced without these specific details. In other instances, well-known methods, procedures, components, and circuits have not been described in detail so as not to unnecessarily obscure aspects of the present invention.

For expository purposes, the term “horizontal” as used herein refers to a plane parallel to the plane or surface of an object, regardless of its orientation. The term “vertical” refers to a direction perpendicular to the horizontal as just defined. Terms such as “above,” “below,” “bottom,” “top,” “side,” “higher,” “lower,” “upper,” “over,” and “under” are referred to with respect to the horizontal plane.

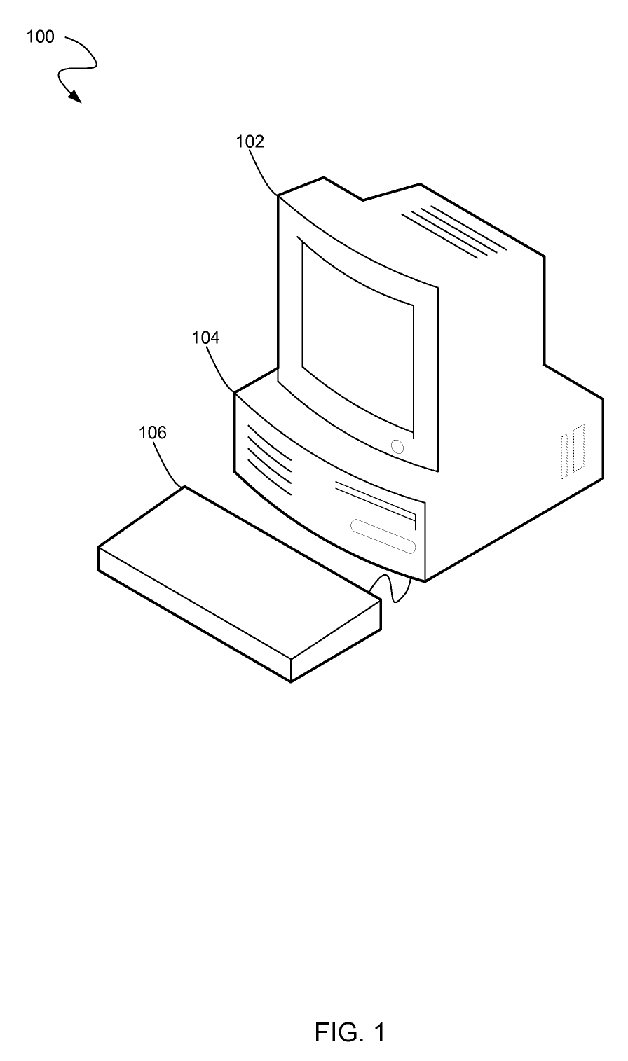

FIG. 1 depicts a prior art personal computer system 100.

Personal computer system 100 is a general-purpose computer intended to be used by an end user. Personal computer system 100 or “desktop” system comprises display 102, tower 104, and user input device 106. Tower 104 includes the main hardware components of personal computer system 100. Tower 104 may include a power supply (not shown), a central processing unit (not shown), memory (not shown, and data storage drives (not shown). Display 102 is coupled to tower 104 and displays content of personal computer system 100. User input device 106 is coupled to tower 104 and is used to interact with personal computer system 100. User input device 106 may be coupled to tower 104 using wireless technology.

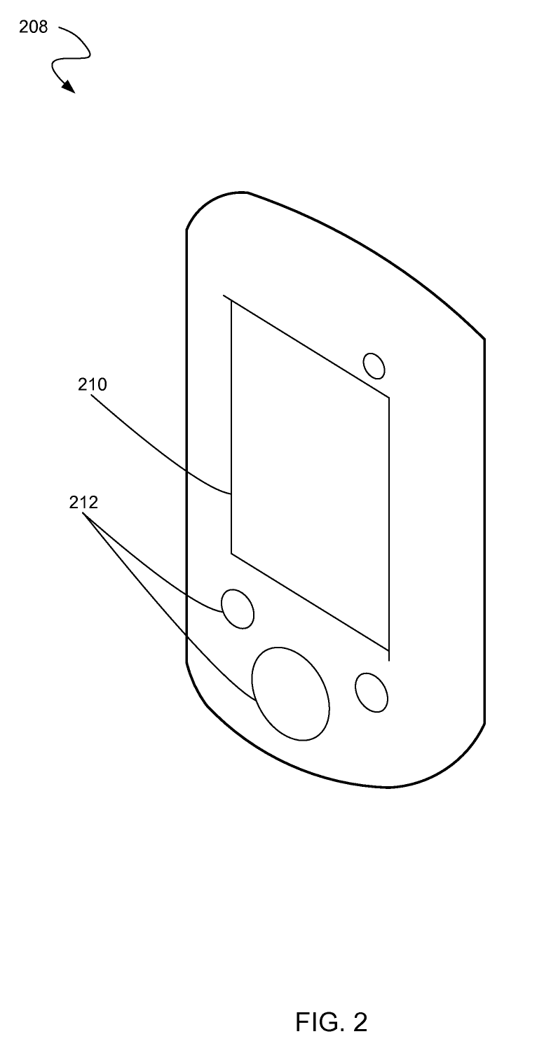

FIG. 2 depicts a prior art wireless computing device 208. Wireless computing device 208 may be a smartphone device, personal digital assistant device, or other mobile computing device. Typically, wireless computing device 208 has a powerful mobile CPU and includes all of the major components of a traditional personal computer system (FIG. 1) in a smaller handheld form factor. Wireless computing device 208 may include input/output connections (not shown) for interfacing with other devices. Additionally, wireless computing device 208 may include wireless connection capabilities such as, but not limited to, near-field communication (NFC), Bluetooth, and Wireless HDMI.

Wireless computing device 208 comprises a mobile display 210 and control buttons 212 for user interaction with the device. Typically, mobile display 210 has a limited viewing area due to screen size restrictions on wireless computing device 208. Wireless computing device 208 may be able to mirror content on mobile display 210 to a larger external display (not shown). However, such mirroring requires a physical display connection from wireless computing device 208 to the larger external display (not shown).

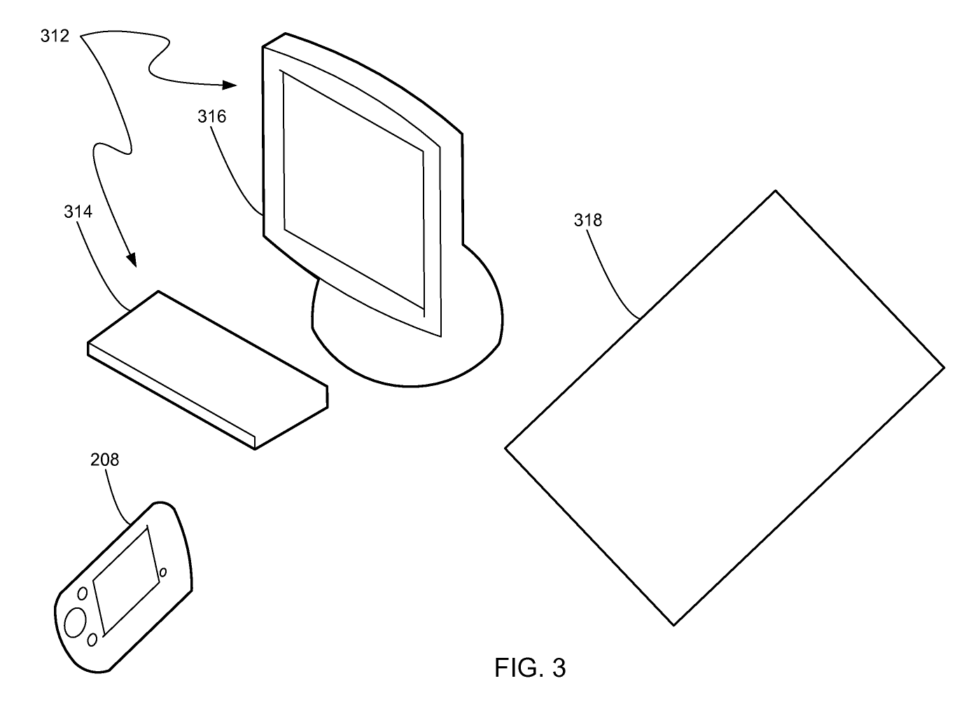

FIG. 3 depicts an exemplary user interface device 312 along with an inductive charging pad 318 in accordance with one embodiment of the present invention. User interface device 312 includes a number of peripheral units for interacting with wireless computing device 208. Peripheral units may include a wireless keyboard 314 and a wireless display 316. Wireless keyboard 314 may incorporate a wireless communication protocol such as Bluetooth®. Wireless display 316 may incorporate a wireless communication protocol such as Wireless HDMI. The peripheral units include a circuit operable to create a wireless communication channel between the peripheral units and wireless computing device 208 using the above mentioned wireless communication protocols.

User interface device 312 may be coupled e.g., wired, with an inductive charging pad 318. Inductive charging pad 318 uses an electromagnetic field to transfer energy via inductive coupling to charge wireless computing device 208 when in close proximity to the inductive charging pad 318. Additionally, inductive charging pad 318 includes a circuit operable to create a pairing between user interface device 312 and wireless computing device 208 using Near Field Communication (NFC). NFC is a set of standards for wireless computing devices to establish radio communication with each other by bringing them into close proximity.

For instance, when wireless computing device 208 is brought into proximity of inductive charging pad 318 and is within an inductive power transfer field, inductive charging pad 318 will automatically associate with wireless computing device 208 via NFC and generate a configuration eligibility signal. The configuration eligibility signal indicates eligibility of wireless computing device 208 to connect to the peripheral units (wireless keyboard 314 and wireless display 316) of user interface device 312 via a wireless communication channel. If wireless computing device 208 is authorized to pair with wireless keyboard 314 and wireless display 316, the NFC connection will create a secure one-time session key for wireless computing device 208 to pair itself automatically with wireless keyboard 314 and wireless display 316 using the wireless communication protocols mentioned above.

A secure one-time session key is created for wireless computing device 208 to automatically pair with wireless keyboard 314 and wireless display 316. The NFC connection also includes information about the peripheral units necessary to create the wireless communication channel between the peripheral units and wireless computing device 208. For example, the NFC connection may include, but is not limited to, information about the manufacturer of the peripheral unit, battery life remaining for the peripheral unit, and the wireless communication protocol used by the peripheral unit, for instance.

Upon creation of the NFC connection between user interface device 312 and wireless computing device 208 and the wireless communication channel between the peripheral units and wireless computing device 208, the peripheral units (wireless keyboard 314 and wireless display 316) will be able to interact with content on the wireless computing device 208. For example, wireless display 316 may either mirror content from wireless computing device 208 or act as a secondary display increasing the total display real estate available on wireless computing device 208. Additionally, wireless keyboard 314 may be used to input keystrokes and commands that control the content present on wireless computing device 208.

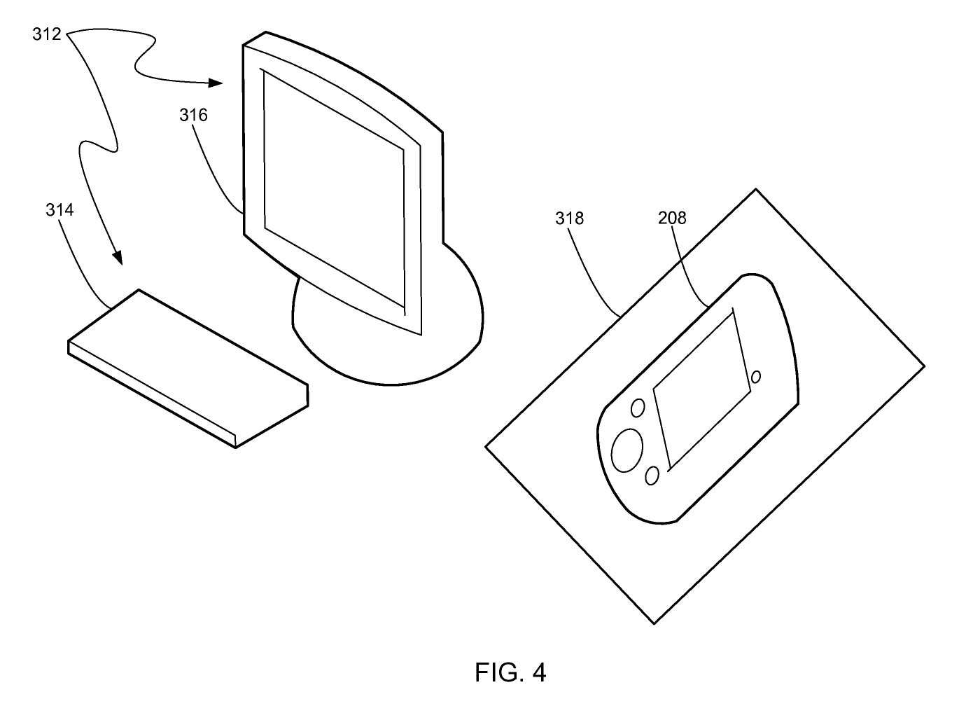

FIG. 4 depicts an exemplary user interface device 312 along with a wireless computing device 208 in proximity to an inductive charging pad 318 in accordance with one embodiment of the present invention. As mentioned above, when wireless computing device 208 is brought into proximity of inductive charging pad 318 and is within an inductive power transfer field, inductive charging pad 318 will associate with wireless computing device 208 and facilitate a pairing between wireless computing device 208 and wireless keyboard 314 and wireless display 316.

When wireless computing device 208 is removed from proximity to inductive charging pad 318, the NFC connection between user interface device 312 and wireless computing device 208 and the wireless communication channel between the peripheral units and wireless computing device 208 are terminated. By having the inductive charging pad 318 control the connectivity of the peripheral units of user interface device 312, more energy intensive interconnect technology may be used on wireless computing device 208 without running its battery down.

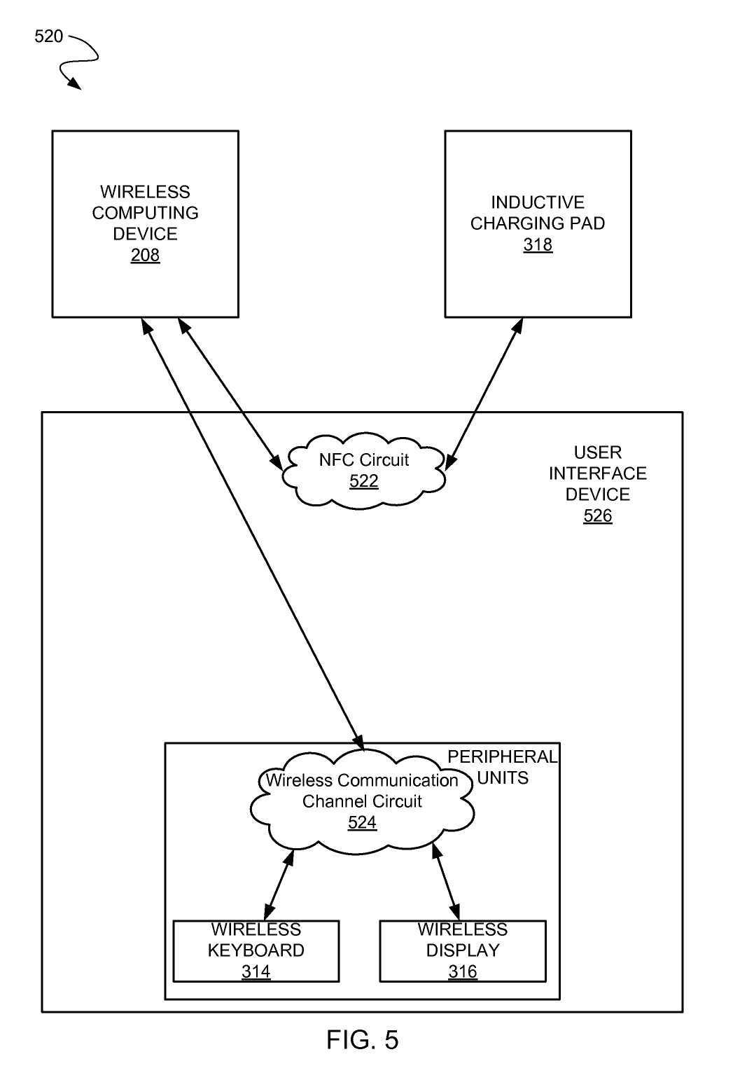

FIG. 5 depicts a block diagram of a mobile compute environment 520 in accordance with one embodiment of the present invention. Mobile compute environment 520 includes wireless computing device 208, inductive charging pad 318, and user interface device 526. User interface device 526 includes NFC circuit 522 and peripheral units that include wireless keyboard 314, wireless display 316, and wireless communication channel circuit 524. As mentioned above, when wireless computing device 208 is brought into proximity of inductive charging pad 318 and is within an inductive power transfer field, inductive charging pad 318 will associate with wireless computing device 208 via NFC and facilitate a pairing between wireless computing device 208 and wireless keyboard 314 and wireless display 316.

A pairing between user interface device 526 and wireless computing device 208 is created by a NFC connection via NFC circuit 522 residing within user interface device 526. Inductive charging pad 318 is responsible for handshaking and initialization of the NFC connection between user interface device 526 and wireless computing device 208 when wireless computing device 208 is within proximity to inductive charging pad 318.

After initial pairing, a wireless communication channel is established between the peripheral units (wireless keyboard 314 and wireless display 316) and wireless computing device 208 via wireless communication channel circuit 524. Wireless communication channel 524 may use wireless protocols such as, but not limited to, Bluetooth® and Wireless HDMI.

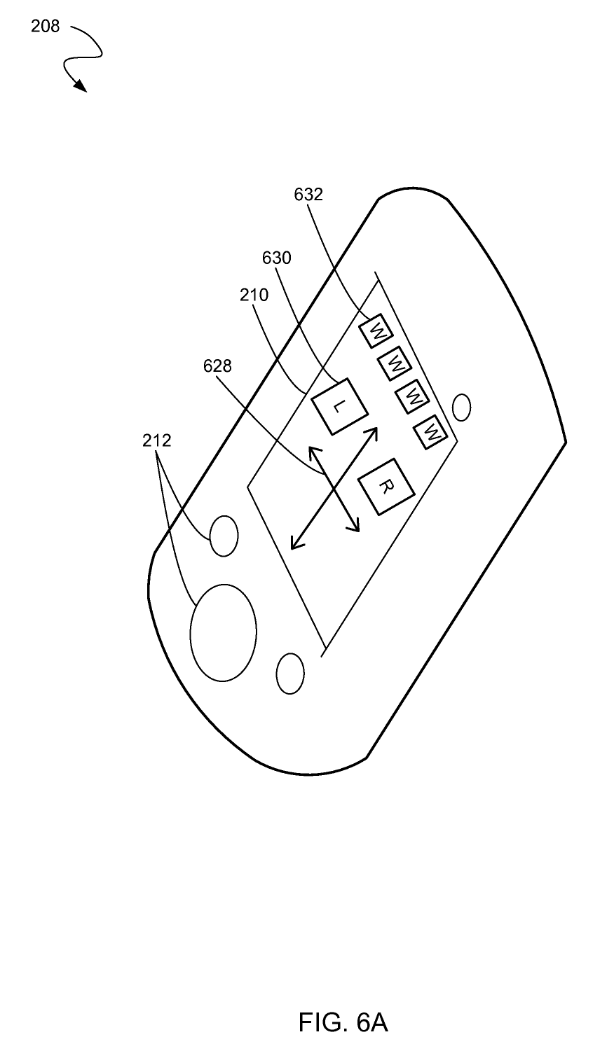

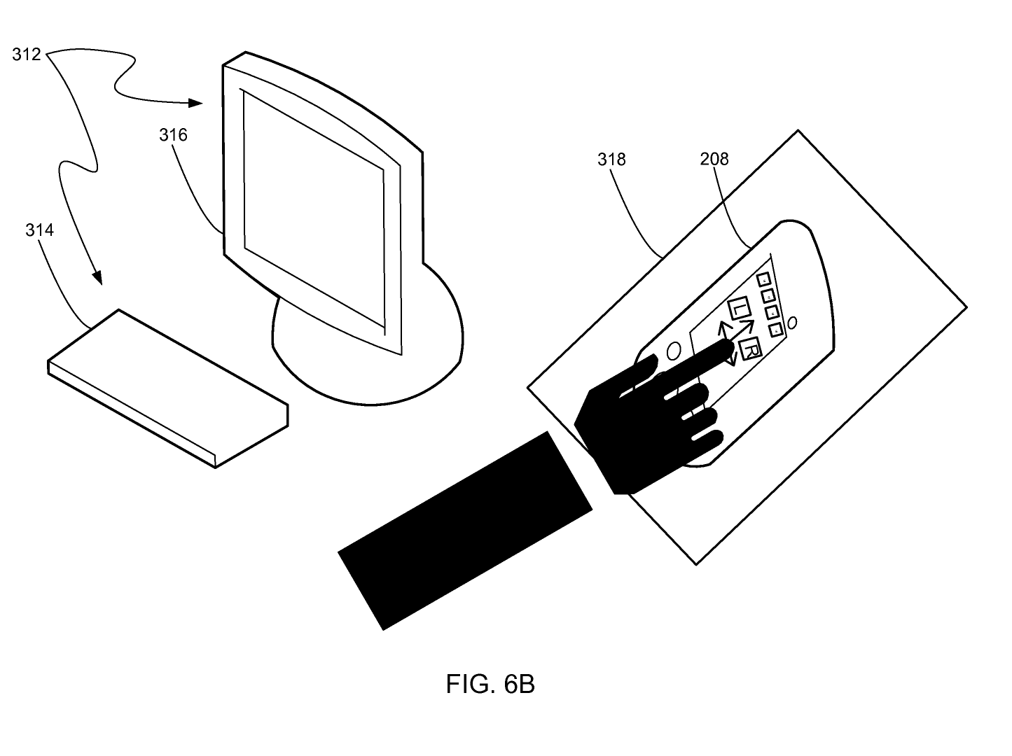

FIG. 6A depicts a wireless computing device 208 operable as a user input device in accordance with one embodiment of the present invention. Wireless computing device 208 comprises a mobile display 210 and control buttons 212 for user interaction with the device. In an embodiment, mobile display 210 may be a multi-touch display that recognizes navigation gestures by a user. Additionally, wireless computing device may include graphical user interface (GUI) widgets 632, GUI arrows 628, and GUI buttons 630 within mobile display 210. GUI widgets 632 are user-definable shortcuts for accessing commonly used content on wireless computing device 208. GUI arrows 628 include up, down, left, and right arrows for navigation of content on wireless computing device 208. GUI buttons 630 include buttons corresponding to a left click and a right click for navigation of content on wireless computing device 208.

In an embodiment, wireless computing device 208 may automatically implement functionality as a user input device upon being placed in proximity to inductive charging pad 318 (FIG. 3). For example, upon placing wireless computing device 208 in proximity to inductive charging pad 318 (FIG. 3), inductive charging pad 318 (FIG. 3) will associate with wireless computing device 208 via NFC and facilitate a pairing between wireless computing device 208 and wireless keyboard 314 (FIG. 3) and wireless display 316 (FIG. 3), as described above. After the association and pairing, wireless computing device 208 may automatically implement user input device functionality so that the user may utilize GUI widgets 632, GUI arrows 628, and GUI buttons 630 for navigation of content on wireless computing device 208 being displayed on wireless display 316 (FIG. 3).

FIG. 6B depicts a wireless computing device operable as a cursor-directing device in accordance with one embodiment of the present invention. In an embodiment, wireless computing device 208 may automatically implement functionality as a user input device upon being placed in proximity to inductive charging pad 318. For example, upon placing wireless computing device 208 in proximity to inductive charging pad 318, inductive charging pad 318 will associate with wireless computing device 208 via NFC and facilitate a pairing between wireless computing device 208 and wireless keyboard 314 and wireless display 316.

Wireless computing device 208 may be used as a cursor-directing device, multi-touch input device, or as both simultaneously. A user may use their fingers to navigate content on wireless computing device 208 or may physically move wireless computing device 208 along a surface of inductive charging pad 318 to navigate content. Inductive charging pad 318 and wireless computing device 208 may implement functionality for optical mouse tracking (see below).

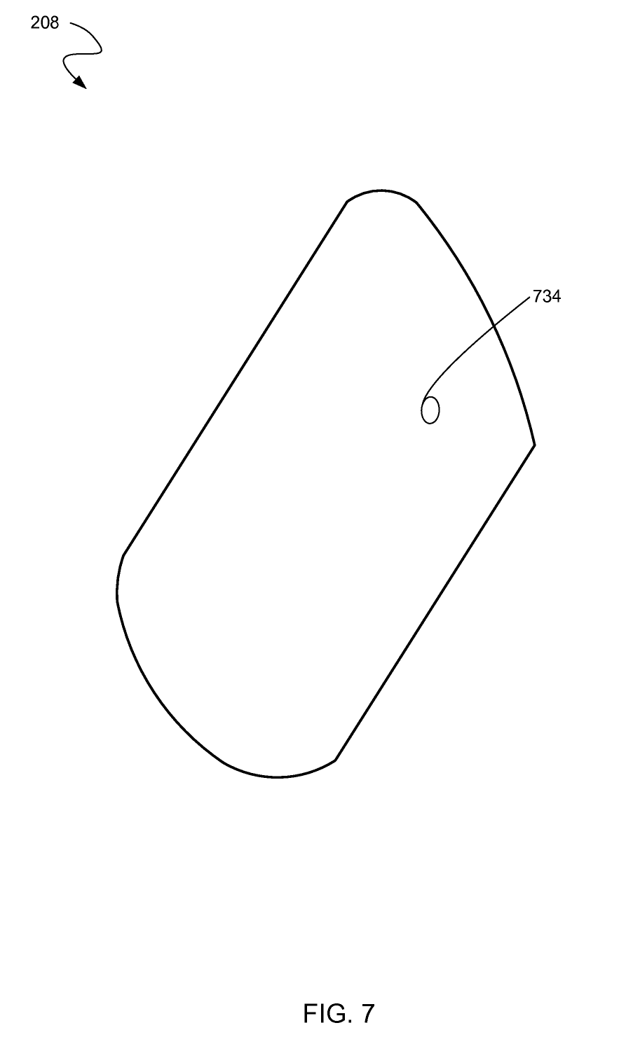

FIG. 7 depicts a rear side of a wireless computing device 208 having a built in optical camera 734 operable as a tracking sensor for a user input device in accordance with one embodiment of the present invention. Wireless computing device 208 includes an optical camera 734 located on its rear. Optical camera 734 may also be located on the front or on either side of wireless computing device 208.

In an embodiment, wireless computing device 208 may be used as a cursor-directing device for navigation of content being displayed on wireless display 316 (FIG. 3), similar to a mouse. Optical camera 734 is typically a high-resolution camera operable to be used as an optical mouse sensor when wireless computing device 208 functions as a cursor-directing device. Optical camera 734 may track on any surface where optical camera 734 can distinguish an optical frame at a first point in time from a frame at a second point in time.

In an embodiment, inductive charging pad 318 (FIG. 3) may include an infrared backlight that creates a non-repeating pattern on its surface. As such, the inductive charging pad 318 (FIG. 3) may function as a tracking surface for wireless computing device 208 when it is used as a cursor-directing device for navigation of content being displayed on wireless display 316 (FIG. 3).

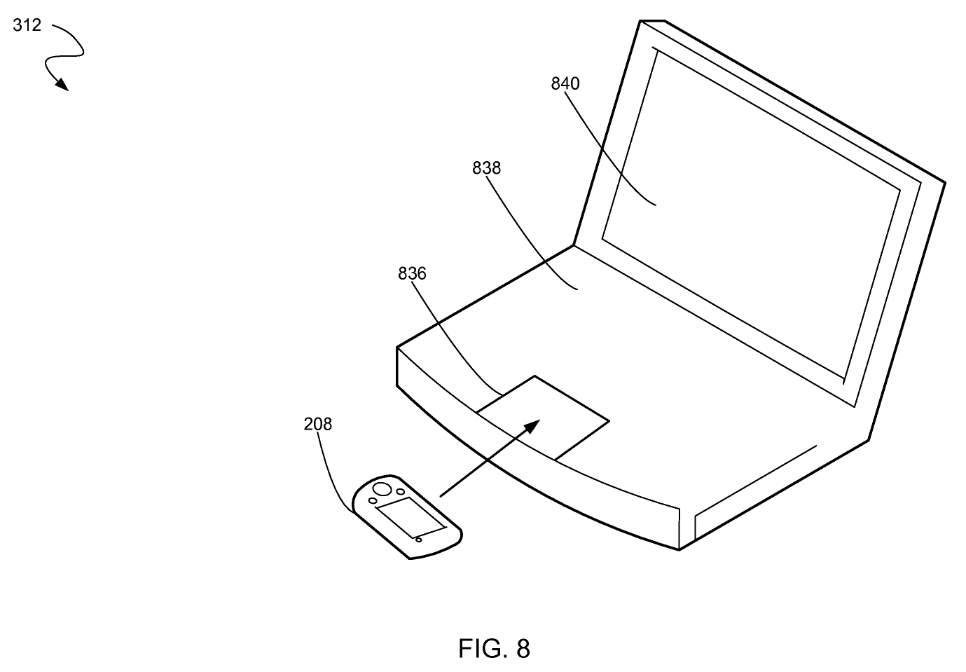

FIG. 8 depicts a user interface device 312 having a slot 836 operable to house a wireless computing device 208 in accordance with one embodiment of the present invention. In an embodiment, user interface device 312 may be a “dummy” laptop terminal having an integrated display 840 and integrated keyboard 838. User interface device 312 may include a slot 836 operable to house wireless computing device 208.

Wireless computing device 208 may function as a user input device when housed in slot 836 and implement similar user input device functionality described above. For example, wireless computing device 208 may function as a touch pad when inserted in slot 836 allowing for navigation of content displayed on integrated display 840. In an embodiment, wireless computing device 208 may automatically implement user input device functionality when inserted into slot 836.

Additionally, when wireless computing device 208 is inserted into slot 836, a pairing may be made between wireless computing device 208 and integrated keyboard 838 and integrated display 840. This pairing is similar to the pairing created when wireless computing device 208 is brought into proximity of the inductive charging pad, as detailed in the embodiments described above.

User input device 208 may sit flush in slot 836 such that integrated display 840 may be closed on top of integrated keyboard 838 while user input device 208 is still housed in slot 836. User interface device 312 may then be transported by a user to another location with user input device 208 is still housed in slot 836.

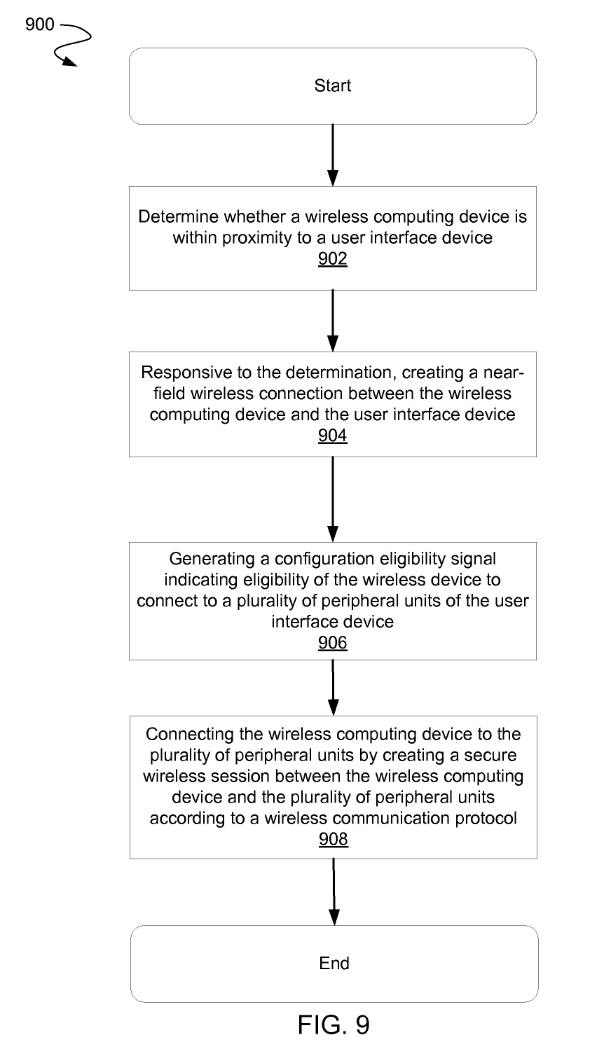

FIG. 9 depicts a flowchart 900 of an exemplary process of pairing a wireless computing device with a user interface device, according to some embodiments of the present invention. In a block 902, a determination is made whether a wireless computing device is within proximity to a user input device. The determination is made upon detection of a NFC communication between the wireless computing device and user interface device. In an embodiment, the wireless computing device may be a smartphone. In another embodiment, the user input device may include a wireless keyboard and wireless display.

For example, in FIG. 4, when wireless computing device is brought into proximity of inductive charging pad and is within an inductive power transfer field, inductive charging pad will determine that wireless computing device is within proximity to the user interface device including the wireless keyboard and wireless display.

In a block 904, responsive to determining whether a wireless computing device is within proximity to a user input device in block 902, a NFC connection between the wireless computing device and the user input device is created. For example, in FIG. 4, when wireless computing device is brought into proximity of inductive charging pad and is within an inductive power transfer field, inductive charging pad will associate with wireless computing device via a NFC connection. In an embodiment, the inductive charging pad may also charge the wireless computing device when the wireless computing device is in proximity to the inductive charging pad.

In a block 906, a configuration eligibility signal indicating eligibility of the wireless device to connect to a plurality of peripheral units of the user input device is generated. For example, in FIG. 4, when wireless computing device is brought into proximity of inductive charging pad and is within an inductive power transfer field, inductive charging pad will associate with wireless computing device via a NFC connection and generate a configuration eligibility signal. The configuration eligibility signal indicates eligibility of wireless computing device to connect to the peripheral units of user interface device via a wireless communication channel.

In an embodiment, the peripheral units of user interface devices comprise a wireless keyboard and wireless display. In another embodiment, upon the inductive charging pad associating with the peripheral units of the user interface device, wireless computing device may automatically implement functionality as a user input device. For example, in FIG. 4, upon placing wireless computing device in proximity to the inductive charging pad, wireless computing device may automatically implement user input device functionality so that the user may utilize GUI widgets, GUI arrows, and GUI buttons for navigation of content on wireless computing device that is being displayed on wireless display, as demonstrated in FIG. 6A. In another embodiment, the wireless computing device may automatically implement functionality as a cursor-directing device.

In a block 908, upon successful pairing, a connection is created between the wireless computing device and the plurality of peripheral units by creating a secure wireless session between the wireless computing device and the plurality of peripheral units according to a wireless communication protocol. In an embodiment, the wireless communication protocols may be Bluetooth® and Wireless HDMI. For example, in FIG. 4, after generating the configuration eligibility signal in block 906, if wireless computing device is authorized to pair with wireless keyboard and wireless display, the NFC connection will create a secure one-time session key for wireless computing device to pair itself automatically with wireless keyboard and wireless display using the wireless communication protocols mentioned above.

When wireless computing device is removed from proximity to inductive charging pad, the NFC connection between user interface device and wireless computing device and the wireless communication channel between the peripheral units and wireless computing device are terminated. By having the inductive charging pad control the connectivity of the peripheral units of user interface device, more energy intensive interconnect technology may be used on wireless computing device without running its battery down.

In an embodiment, the wireless display mirrors content from the wireless computing device. In another embodiment, the wireless display acts as a secondary display for the wireless computing device. In yet another embodiment, user keyboard input from the wireless keyboard is received and communicated to the wireless computing device.

In the foregoing specification, embodiments of the invention have been described with reference to numerous specific details that may vary from implementation to implementation. Thus, the sole and exclusive indicator of what is, and is intended by the applicants to be, the invention is the set of claims that issue from this application, in the specific form in which such claims issue, including any subsequent correction. Hence, no limitation, element, property, feature, advantage, or attribute that is not expressly recited in a claim should limit the scope of such claim in any way. Accordingly, the specification and drawings are to be regarded in an illustrative rather than a restrictive sense.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings.

What is claimed is:

1. An apparatus comprising:
a user interface device comprising a plurality of peripheral units and a first circuit, wherein said plurality of peripheral units comprise a second circuit, wherein further said first circuit is operable to create a pairing between said user interface device and a wireless computing device via a near-field wireless connection, and wherein further said second circuit is operable to create a wireless communication channel between said plurality of peripheral units and said wireless computing device via a wireless communication protocol.

2. The apparatus of claim 1 further comprising an inductive charging pad operable for charging said wireless computing device wherein said inductive charging pad generates a configuration eligibility signal upon said wireless computing device placed in proximity to said inductive charging pad, and wherein further said configuration eligibility signal indicates eligibility of said wireless computing device to connect to said plurality of peripheral units.

3. The apparatus of claim 2 wherein said first circuit is initiated to create said near-field wireless connection upon said wireless computing device placed in proximity to said inductive charging pad and wherein further said near-field wireless connection comprises:
information about said plurality of peripheral units; and
information operable to create a secure session for said wireless computing device to pair with said plurality of peripheral units.

4. The apparatus of claim 3 wherein said near-field wireless connection and said wireless communication channel terminate upon removal of said wireless computing device from proximity to said inductive charging pad.

5. The apparatus of claim 1 wherein said plurality of peripheral units comprise a wireless keyboard and a wireless display device, and wherein further said plurality of peripheral units is used to interact with content on said wireless computing device.

6. The apparatus of claim 5 wherein said wireless display device is operable to mirror content on said wireless computing device or serve as a secondary display for said wireless computing device.

7. The apparatus of claim 1 wherein said user interface device comprises a slot operable to house said wireless computing device and wherein further said wireless computing device is operable as a user input device when housed in said slot.

8. An apparatus comprising:
a user interface device comprising a plurality of user interface peripheral units and a first circuit, wherein said plurality of user interface peripheral units comprise a second circuit, wherein further said first circuit is operable to create a pairing between said user interface device and a wireless computer via a near-field wireless connection, wherein further said second circuit is operable to create wireless communication channels between said plurality of user interface peripheral units and said wireless computer via a wireless communication protocol, and wherein further said wireless computer is operable as a user input device.

9. The apparatus of claim 8 further comprising an inductive charging pad operable for charging said wireless computer wherein said inductive charging pad generates a configuration eligibility signal upon said wireless computer placed in proximity to said inductive charging pad, wherein further said configuration eligibility signal indicates eligibility of said wireless computer to connect to said plurality of user interface peripheral units, and wherein further said plurality of peripheral units is used to interact with content on said wireless computer.

10. The apparatus of claim 9 wherein said first circuit is initiated to create said near-field wireless connection upon said wireless computer placed in proximity to said inductive charging pad, and wherein further said near-field wireless connection comprises:
information about said plurality of user interface peripheral units; and
information operable to create a secure session for said wireless computer to pair with said plurality of user interface peripheral units.

11. The apparatus of claim 9 wherein said near-field wireless connection and said wireless communication channels terminate upon removal of said wireless computer from proximity to said inductive charging pad.

12. The apparatus of claim 9 wherein said wireless computer automatically implements functionality of said user input device upon placing said wireless computer in proximity to said inductive charging pad.

13. The apparatus of claim 9 wherein said user input device is a cursor directing device and wherein further said inductive charging pad comprises an infrared backlight creating a non-repeating pattern on a surface of said inductive charging pad operable as a tracking surface for said wireless computer.

14. The apparatus of claim 8 wherein said user input device is a cursor directing device and wherein further said wireless computer comprises a high resolution camera operable to be used as an optical mouse sensor when said wireless computer functions as a user input device for said plurality of user interface peripheral units.

15. The apparatus of claim 8 wherein said user input device is a cursor directing device and wherein further said wireless computer comprises a multi-touch display operable to recognize navigation gestures when said wireless computer functions as a user input device for said plurality of user interface peripheral units.

16. The apparatus of claim 8 wherein said wireless computer comprises a display operable to display:
graphical user interface widgets to access commonly used content on said wireless computer;
graphical user interface arrows for navigation of content on said wireless computer; and
graphical user interface buttons corresponding to a left click and right click for graphical user navigation of content on said wireless computer.

17. The apparatus of claim 8 wherein said wireless communication channels comprise Bluetooth or Wireless HDMI.

18. The apparatus of claim 8 wherein said plurality of user interface peripheral units comprise a wireless keyboard and a wireless display device, and wherein further said plurality of user interface peripheral units is used to interact with content on said wireless computer.

18. A method comprising:
detecting whether a wireless computing device is within proximity to a user interface device;
responsive to said detecting, creating a near-field wireless connection between said wireless computing device and said user interface device for pairing thereof;
generating a configuration eligibility signal indicating eligibility of said wireless computing device to connect to a plurality of peripheral units of said user interface device; and
provided said pairing is complete, connecting said wireless computing device to said plurality of peripheral units by creating a secure wireless session between said wireless computing device and said plurality of peripheral units according to a wireless communication protocol.

19. The method of claim 18 wherein said plurality of peripheral units comprise a wireless display device and further comprising mirroring content from said wireless computing device to said wireless display device.

20. The method of claim 18 further comprising terminating said near-field wireless connection and said secure wireless session upon removal of said wireless computing device from proximity to said user interface device.

21. The method of claim 18 further comprising initiating user interface functionality on said wireless computing device wherein said wireless computing device is operable as cursor directing device for said user interface device.

22. The method of claim 18 wherein said user interface device further comprises an inductive charging pad and further comprises charging said wireless computing device when said wireless computing device is within proximity to said inductive charging pad.

23. The method of claim 18 wherein said plurality of peripheral units comprise a display and a keyboard and further comprising displaying information from said wireless computing device on said display and receiving user information from said keyboard and communicating said user information to said wireless computing device.
